(19) United States
(12) Patent Application Publication
(10) Pub. No.: US 2008/0034957 A1
(43) Pub. Date: Feb. 14, 2008

(54) Hydraulic Actuator Control Circuit With Pressure Operated Counterbalancing Valves

(76) Inventors: Dwight B. Stephenson, Oconomowoc, WI (US); Joseph L. Pfaff, Wauwatosa, WI (US); Christopher J. Kolbe, Muskego, WI (US); Robert J. Valenta, Stockport (GB); Eric P. Hamkins, Waukesha, WI (US)

Correspondence Address: QUARLES & BRADY LLP, 411 E. WISCONSIN AVENUE, SUITE 2040, MILWAUKEE, WI, 53202-4497, US

(21) Appl. No.: 11/463,486

(22) Filed: Aug. 9, 2006

(51) Int. Cl. F15B 13/04

(52) U.S. Cl. 91/454

(57) ABSTRACT

A valve assembly controls fluid flow between first and second ports of a hydraulic actuator and each of a supply line and a return line. A first electrohydraulic proportional valve is connected between the supply line and the first port, and second electrohydraulic proportional valve is connected between the supply line and the second port. A first counterbalance valve couples the second port to the return line and operates in response to pressure created by the first electrohydraulic proportional valve and the first port. A second counterbalance valve couples the first port to the return line and operates in response to pressure created by the second electrohydraulic proportional valve and the second port. Thus operation of the first counterbalance valve is slaved to the first electrohydraulic proportional valve, and the second counterbalance valve is slaved to the second electrohydraulic proportional valve.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to hydraulic systems for operating machines, such as agricultural, construction and industrial equipment; and particularly to a valve assembly for controlling the flow of fluid to and from a hydraulic actuator on the machine.

2. Description of the Related Art

Agricultural, construction and industrial equipment have moveable members which are operated by hydraulic actuators, such as cylinder and piston arrangements and hydraulic motors. Application of hydraulic fluid to the hydraulic actuator traditionally was controlled by a valve that had a spool which was moved by a manually operated lever. Movement of the spool into various positions within a valve body proportionally varied the flow of pressurized fluid to flow from a pump to one chamber of the cylinder and the flow of fluid draining from another cylinder chamber. Varying the fluid flow rates drove the piston, and thus the machine member coupled thereto, at proportionally different speeds.

There is a present trend away from manually operated hydraulic valves toward electrical controls and the use of solenoid valves. This type of control simplifies the hydraulic plumbing as the control valves do not have to be located near the operator cab and can be mounted adjacent the associated hydraulic actuator. Electrically operated valves also enables computer control of the actuators.

A common electrically controlled hydraulic system, employed a Wheatstone bridge arrangement of four electrohydraulic proportional poppet valves with each one fluidically connected between two different corners of a square. Two opposing corners of the bridge were connected to the two cylinder chambers. One remaining corner was coupled to the supply conduit carrying pressurized fluid and the last corner was connected to the tank return conduit. To operate the hydraulic cylinder, two valves on opposite sides of the bridge were opened so that fluid from the supply conduit flowed into one cylinder chamber and the fluid exiting the other cylinder chamber flowed to the return conduit. Which pair of opposite valves were opened determined the direction, extension or retraction, of the cylinder motion. Even though two electrohydraulic proportional valves on opposite sides of the bridge were opened in unison, each of those valve was electrically operated independently, thereby requiring a separate electrical actuator and drive circuit. This enabled independent metering of the fluid flow to the hydraulic actuator and the flow from the hydraulic actuator.

### SUMMARY OF THE INVENTION

A control valve assembly is provided for a hydraulic system that has a supply line conveying pressurized fluid, a return line connected to a tank, and a hydraulic actuator. The control valve assembly includes a first workport and a second workport for connecting the hydraulic actuator to the control valve assembly. A first electrohydraulic proportional valve connected between the supply line and the first workport for controlling flow of fluid there between. A second electrohydraulic proportional valve connects the supply line to the second workport and controls the flow of fluid there between.

A first counterbalance valve is connected between the return line and the second workport and controls fluid flow there between in response to pressure at a first node between the first electrohydraulic proportional valve and the first workport. A second counterbalance valve is connected between the return line and the first workport and controls fluid flow in response to pressure at a second node between the second electrohydraulic proportional valve and the second workport.

A preferred embodiment, also provides a first check valve in parallel with the first counterbalance valve and allows fluid flow only from the return line to the second workport. In this embodiment, a second check valve also is connected in parallel with the second counterbalance valve and allows fluid flow only from the return line to the first workport.

In another version of the control valve assembly, a first load check valve is connected between the first node and the first workport, and permits fluid flow only from the first electrohydraulic proportional valve to the first workport. A second load check valve connects the second node to the second workport, allowing fluid flow only from the second electrohydraulic proportional valve to the second workport.

### BRIEF DESCRIPTION OF THE DRAWINGS

FIG. 1 illustrates a telehandler incorporating the present invention; and

FIG. 2 is a schematic diagram of the hydraulic circuit of the telehandler.

### DETAILED DESCRIPTION OF THE INVENTION

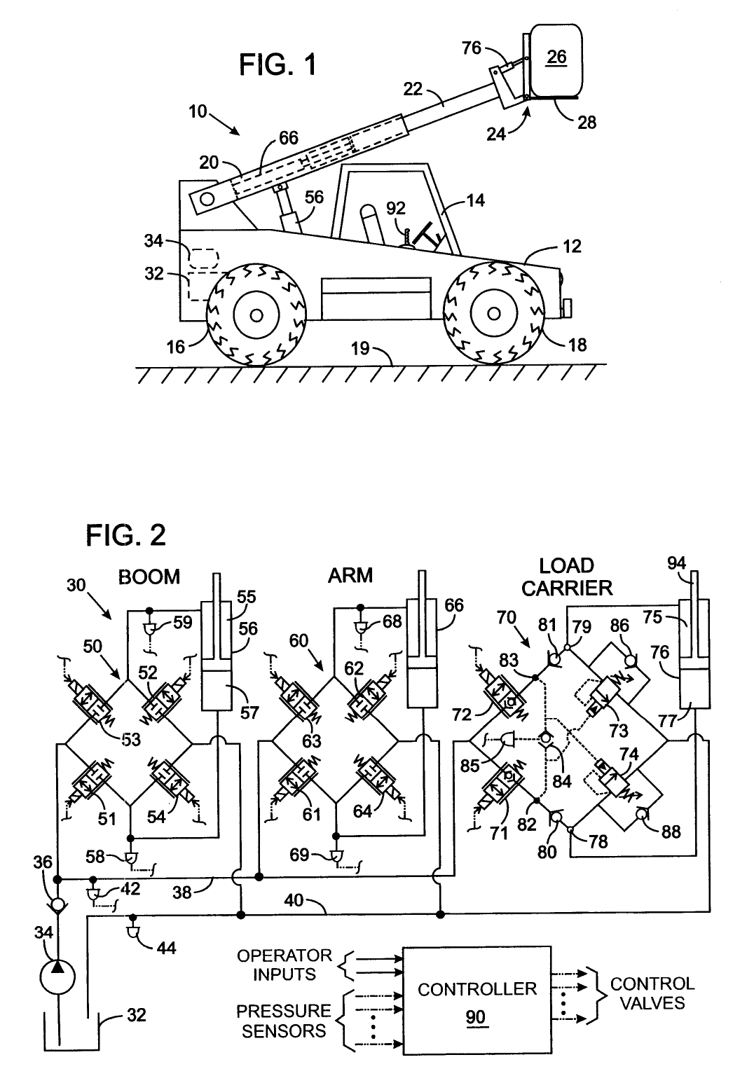

With initial reference to FIG. 1, a telehandler 10 is an example of a machine on which the present invention can be used, with the understanding that the invention has application to a wide variety of machines. The telehandler 10 has a carriage 12 with an operator cab 14. The carriage 12 supports an engine or battery powered motor (not shown) for driving a pair of rear wheels 16 across the ground 19. A pair of front wheels 18 are steered from the operator cab 14. A boom 20 is pivotally attached to the rear of the carriage 12 and an arm 22 slides telescopically within the boom. A load carrier 24 is pivotally mounted at the end of the arm 22 that is remote from the boom 20 and can comprise any one of several structures for lifting a load 26. For example, the load carrier 24 may have a pair of forks 28 to lift a pallet on which goods are packaged.

With additional reference to FIG. 2, the telehandler 10 has a hydraulic system 30 that controls movement of the boom 20, the arm 22, and the load carrier 24. Hydraulic fluid is held in a reservoir, or tank, 32 from which the fluid is drawn by a conventional pressure and flow compensated pump 34 and fed through a check valve 36 into a supply line 38 that runs through the telehandler. Alternatively, an open center pump may be utilized with an unload valve at its outlet to control the output pressure. A tank return line 40 also runs through the telehandler and provides a conduit for the hydraulic fluid to flow back to the tank 32. A pair of pressure sensors 42 and 44 provide electrical signals that indicate the pressure in the supply line 38 and the tank return line 40, respectively.

The supply line 38 furnishes hydraulic fluid to a first control valve assembly 50 comprising a Wheatstone bridge configuration of four electrohydraulic proportional (EHP) valves 51, 52, 53 and 54 which control the flow of fluid to and from a boom hydraulic cylinder 56 that raises and lowers the boom 20. Each of these EHP valves 51-54 and other electrohydraulic proportional valves in the system 30 have only two ports and preferably are bidirectional poppet valves, thereby controlling flow of hydraulic fluid flowing in either direction through the valve and may be the type described in U.S. Pat. No. 6,328,275, for example. However, other types of control valves can be used.

A first pair of the EHP valves 51 and 52 governs the fluid flow from the supply line 38 into a head chamber 57 on one side of the piston in the boom cylinder 56 and from a rod chamber 55 on the opposite side of the piston to the tank return line 40. This action extends the piston rod from the cylinder 56 and raises the boom 20. A second pair of EHP valves 53 and 54 controls the fluid flow from the supply line into the rod chamber 55 and from the head chamber 57 to the tank return line, which retracts the piston rod into the cylinder 56 thereby lowering the boom 20. By controlling the rate at which pressurized fluid is sent into one cylinder chamber and drained from the other chamber, the boom 20 can be raised and lowered in a controlled manner. A first pair of pressure sensors 58 and 59 provide electrical signals indicating the pressure in the two chambers of the boom cylinder 56.

A second control valve assembly 60 controls the flow of hydraulic fluid into and out of an arm hydraulic cylinder 66. This control valve assembly comprises another set of four EHP valves 61, 62, 63, and 64 connected in a Wheatstone bridge configuration between the supply and tank return lines 38 and 40 and the chambers of the arm cylinder 66. Operation of the second control valve assembly 60 extends and retracts the arm 22 with respect to the boom 20. A second pair of pressure sensors 68 and 69 provide electrical signals indicating the pressure in the two chambers of the arm hydraulic cylinder 66.

A third control valve assembly 70 controls fluid flow to and from a load carrier hydraulic cylinder 76 that tilts the load carrier 24 up and down with respect to the remote end of the arm 22. This valve assembly differs from the others in that it has only two EHP valves 71 and 72 that are combined with two pressure operated counterbalance valves 73 and 74. The first EHP valve 71 controls flow of fluid from the supply line 38 to a first workport 78 to which a first port for the head chamber 77 of the load carrier cylinder 76 connects, and the second EHP valve 72 controls fluid flow from the supply line to a second workport 79 coupled to a second port for the rod chamber 75. A first load check valve 80 is provided in the path between the first EHP valve 71 and the head chamber, and a second load check valve 81 is provided in the path between the second EHP valve 72 and the rod chamber.

The first counterbalance valve 73 couples the rod chamber 75 to the tank return line 40, while a second counterbalance valve 74 is connected between the head chamber 77 and the tank return line. The two counterbalance valves 73 and 74 are pressure operated pilot valves. The first counterbalance valve 73 is operated by pressure at a first node 82 between the first EHP valve 71 and a first load check valve 80 and thus is slaved non-electrically to operate in unison with that EHP valve. The second counterbalance valve 74 is operated by pressure at a second node 83 between the second EHP valve 72 and the second load check valve 81, thereby being slaved non-electrically to operate in unison with the second EHP valve. The internal checking function of the first or second EHP valve 71 or 72 in conjunction with the operation of the associated first or second load check valves 80 or 81 and the inherent return line leakage in the respective first or second counterbalance valve 73 or 74 ensure that the appropriate counterbalance valve opens with opening of whichever EHP valve is electrically activated to open. A first or second check valve 86 or 88 is an integrated part and function of the first or second counterbalance valve 73 or 74, respectively, and allows flow only from the tank return line to the associated workport 78 or 79 to prevent cavitation in the cylinder 76.

The greater of the pressures at the first and a second nodes 82 and 83 is selected by a shuttle valve 84 and applied to a load pressure sensor 85. When one of the first or second EHP valve 71 or 72 is open, the selected pressure corresponds to the pressure in the workport connected to that opened EHP valve. This occurs even if the other workport has a greater load pressure, because the first or second check valve 86 or 88 prevents that greater pressure from reaching the shuttle valve 84.

The three control valve assemblies 50, 60, and 70 are operated by electrical signals from an electronic controller 90. The controller 90 has a conventional hardware design that is based around a microcomputer and a memory in which programs and data used by the microcomputer are stored. The microcomputer is connected input and output circuits within the controller that interface to the operator input devices, sensors, and valves of the hydraulic system 30. Specifically, the controller 90 receives an operator input signal from a joystick 92 in the telehandler operator cab 14 (FIG. 1) indicating motion the boom-arm-load carrier assembly desired by the operator. Signals from the pressure sensors 42, 44 58, 59, 68, 69, and 85 also are received by the controller. During execution of the control software, the controller 90 responds to those input signals by generating signals that operate the valves in the three control valve assemblies 50, 60 and 70.

To command the controller 90 to move the load carrier 24, the operator manipulates the joystick 92 in a manner that indicates the desired motion. That action sends a signal to the controller 90 that in response determines which one of the first and second EHP valves 71 and 72 should be opened to produce that motion in the desired direction. If the joystick signal designates that the ends of the forks 28 on the load carrier 24 are desired to be tilted downward, the piston rod 94 has to be extended from the load carrier cylinder 76. Therefore, the first EHP valve 71 must be opened to convey fluid from the supply line 38 to the head chamber 77. That fluid forces the first check valve 80 open allowing the fluid to enter the head chamber 77. This action results in a relatively high pressure occurring at the first node 82 between first EHP valve 71 and the first check valve 80. That pressure is applied to the first counterbalance valve 73 forcing that valve to open and provide a path between the rod chamber 75 of the load carrier cylinder 76 and the tank return line 40. Thus pressurized fluid is applied to the head chamber 77 and the fluid in the rod chamber 75 drains into the tank 32, thereby extending the piston rod 94 from the load carrier cylinder.

If the signal from the joystick 92 designates that the ends of the load carrier forks 28 are to be tilted upward, the piston rod 94 has to be retracted into the load carrier cylinder 76. To accomplish that movement, the second EHP valve 72 must be opened to convey fluid from the supply line 38 to the rod chamber 75. Now a relatively high pressure occurs at the second node 83 between second EHP valve 72 and the second check valve 81, which forces the second counterbalance valve 74 open providing a drain path between the head chamber 77 and the tank return line 40. As a result of this action, pressurized fluid is applied to the rod chamber 75 and the fluid in the head chamber 77 drains into the tank 32, thereby retracting the piston rod 94 into the load carrier cylinder.

Thus fluid flow that drives the load carrier cylinder 76 in opposite directions is controlled by a valve assembly 70 that has only two electrically operated valves. Thus the number of electrical actuators and the amount of electrical drive circuitry needed to operate the third valve assembly 70 is reduced from that required for the other valve assemblies 50 and 60 which each have four electrically operated valves. For the load carrier cylinder 76, the two EHP valves 71 and 72 control the application of pressurized fluid from the supply line 38 and the two counterbalance valves 73 and 74, slaved to operation of those EHP valves, control the fluid draining from the load carrier cylinder.

The foregoing description was primarily directed to a preferred embodiment of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

1. A control valve assembly for a hydraulic system having a supply line conveying pressurized fluid, a return line connected to a tank, and a hydraulic actuator, said control valve assembly comprising:
a first workport and a second workport for connecting the hydraulic actuator to the control valve assembly;
a first proportional valve connected between the supply line and the first workport and controlling flow of fluid there between;
a second proportional valve connected between the supply line and the second workport and controlling flow of fluid there between;
a first counterbalance valve connected between the return line and the second workport and slaved to operate in unison with the first proportional valve; and
a second counterbalance valve connected between the return line and the first workport and slaved to operate in unison with the second proportional valve.

2. The control valve assembly as recited in claim 1 wherein the first proportional valve and the second proportional valve are electrically operated.

3. The control valve assembly as recited in claim 1 wherein the first proportional valve and the second proportional valve are poppet valves.

4. The control valve assembly as recited in claim 1 wherein the first counterbalance valve is non-electrically slaved to the first proportional valve; and the second counterbalance valve is non-electrically slaved to the second proportional valve.

5. The control valve assembly as recited in claim 1 wherein:
the first counterbalance valve operates in response to pressure resulting from operation of the first proportional valve; and
the second counterbalance valve operates in response to pressure resulting from operation of the second proportional valve.

6. The control valve assembly as recited in claim 1 wherein:
the first counterbalance valve controls flow of fluid between the return line and the second workport in response to pressure at a first point between the first proportional valve and the first workport; and
a second counterbalance valve controls flow of fluid between the return line and the first workport in response to pressure at a second point between the second proportional valve and the second workport.

7. The control valve assembly as recited in claim 6 further comprising:
a first load check valve, connected between the first point and the first workport, allowing fluid flow only from the first proportional valve to the first workport; and
a second load check valve connected between the second point and the second workport, allowing fluid flow only from the second proportional valve to the second workport.

8. The control valve assembly as recited in claim 7 further comprising a shuttle valve having a first inlet connected to the first point and a second inlet connected to the second point, and an outlet at which appears pressures at the first point or the second point whichever is greater.

9. The control valve assembly as recited in claim 1 further comprising a load sense circuit that, when either one of the first and second proportional valves is open, provides a signal indicating pressure at the first or second workport to which that open proportional valve is connected, regardless of pressure at the other one of the first and second workports.

10. The control valve assembly as recited in claim 1 further comprising:
a first load check valve operably connected to allow fluid flow only from the first proportional valve to the first workport; and
a second load check valve operably connected to allow fluid flow only from the second proportional valve to the second workport.

11. The control valve assembly as recited in claim 1 further comprising:
a check valve connected in parallel with the first counterbalance valve and allowing fluid flow only from the return line to the second workport; and
another check valve connected in parallel with the second counterbalance valve and allowing fluid flow only from the return line to the first workport.

12. The control valve assembly as recited in claim 10 wherein:
the first counterbalance valve controls flow of fluid between the return line and the second workport in response to pressure resulting from operation of the first electrohydraulic proportional valve; and
the second counterbalance valve controls flow of fluid between the return line and the first workport in response to pressure resulting from operation of the second electrohydraulic proportional valve.

13. A control valve assembly for a hydraulic system having a supply line conveying pressurized fluid, a return line connected to a tank, and a hydraulic actuator with a first port and a second port, said control valve assembly comprising:
a first node and a second node;
a first electrohydraulic proportional valve connected between the supply line and the first node, and controlling flow of fluid there between;
a first load check valve operably connected to allow fluid flow only from the first node to the first port of the hydraulic actuator;
a second electrohydraulic proportional valve connected between the supply line and the second node, and controlling flow of fluid there between;
a second load check valve operably connected to allow fluid flow only from the second node to the second port of the hydraulic actuator;
a first counterbalance valve connected between the return line and the second port and controlling flow of fluid there between in response to pressure at the first node between the first electrohydraulic proportional valve and the first port; and
a second counterbalance valve connected between the return line and the first port and controlling flow of fluid there between in response to pressure at the second node between the second electrohydraulic proportional valve and the second port.

14. The control valve assembly as recited in claim 13 further comprising:
a first check valve connected in parallel with the first counterbalance valve and allowing fluid flow only from the return line to the second port; and
a second check valve connected in parallel with the second counterbalance valve and allowing fluid flow only from the return line to the first port.

15. The control valve assembly as recited in claim 13 further comprising a load sense circuit providing a signal indicating the greater of the pressures at the first and second nodes.

16. The control valve assembly as recited in claim 15 wherein the first and second electrohydraulic proportional valves are poppet valves.

17. A control valve assembly for a hydraulic system having a supply line conveying pressurized fluid, a return line connected to a tank, and a hydraulic actuator, said control valve assembly comprising:
a first workport and a second workport for connecting the hydraulic actuator to the control valve assembly;
a first electrohydraulic proportional valve connected between the supply line and the first workport and controlling flow of fluid there between;
a second electrohydraulic proportional valve connected between the supply line and the second workport and controlling flow of fluid there between;
a first counterbalance valve connected between the return line and the second workport and controlling fluid flow there between in response to pressure at a first node between the first electrohydraulic proportional valve and the first workport; and
a second counterbalance valve connected between the return line and the first workport and controlling fluid flow there between in response to pressure at a second node between the second electrohydraulic proportional valve and the second workport.

18. The control valve assembly as recited in claim 17 further comprising:
a first check valve connected in parallel with the first counterbalance valve and allowing fluid flow only from the return line to the second workport; and
a second check valve connected in parallel with the second counterbalance valve and allowing fluid flow only from the return line to the first workport.

19. The control valve assembly as recited in claim 17 wherein the first and second electrohydraulic proportional valves are poppet valves.

20. The control valve assembly as recited in claim 17 further comprising:
a first load check valve connected between the first node and the first workport, and allowing fluid flow only from the first electrohydraulic proportional valve to the first workport; and
a second load check valve connected between the second node and second workport, allowing fluid flow only from the second electrohydraulic proportional valve to the second workport.

21. The control valve assembly as recited in claim 17 further comprising a load sense circuit providing a signal indicating the greater of the pressures at the first and second nodes.
